(19) United States
(12) Patent Application Publication
(10) Pub. No.: US 2006/0007701 A1
(43) Pub. Date: Jan. 12, 2006

(54) Foil display with two light guides

(75) Inventors: Volker Schoellmann, Eindhoven (NL); Tijsbert Mathieu Henricus Creemers, Nijmegen (NL); Simon Robert Marsh, Zandvoort (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/520,193

(22) PCT Filed: Jun. 16, 2003
(86) PCT No.: PCT/IB03/02402

§ 371 Date: Jan. 4, 2005

(30) Foreign Application Priority Data
Jul. 8, 2002 (EP) 02077732.2

(51) Int. Cl. F21V 7/04

(52) U.S. Cl. 362/606; 362/630

(57) ABSTRACT

A display device is described, which comprises a movable element (17) and selection means (15, 16) for locally bringing the movable element into contact with a selected one of two light guides (11, 12), arranged on either sides of the movable element. This provides an essentially symmetric display device, with one light guide on each side of the movable element. The display can display information in two directions, and the selection means can be controlled in a suitable way to activate selected portions of the guides. The invention can be used to provide a bi-directional display.

The present invention relates to a display device comprising a light guide, a movable element and selection means for locally bringing the movable element into contact with the light guide.

Such a display device is normally referred to as “foil” display, as the movable element typically is a thin foil clamped between the light guide and a passive plate. The foil can be actuated by electrostatic forces created by applying voltages to electrodes arranged on the light guide and on the passive plate. Such a display is disclosed in e.g. WO 99/28890.

In some situations, it is desirable to provide a display device which is capable of displaying information in two directions, i.e. from both sides of a screen.

Previously, solutions to this problem have been based on using the double number of pixels. The even pixels are used to generate an image on one side of a screen, while the odd pixels are used to generate an image on the other side. Such a display can be made by means of a large number of display technologies (PolyLED, E-ink) by alternate structuring of neighboring pixels.

These two-way displays, however, have some limitations. Only half of the pixel is an active viewing area. Thus, the display will not be very bright. Moreover, twice the number of pixels, column drivers and column electrodes are required. The fact that, at least, one front light is needed limits the size of the display (to smaller than about 5″).

It is an object of the present invention to provide a display which is capable of displaying information in two directions, wherein all pixels are used to generate an image.

These objects are achieved with a display device of the kind mentioned in the opening paragraph, further comprising a second light guide, wherein the movable element is arranged in between said light guides, and wherein the selection means are arranged to locally bring the movable element into contact with a selected one of said light guides.

According to the invention, an essentially symmetric display device is provided, with one light guide on each side of the movable element. The display can thereby display information in two directions, and the selection means can be controlled in a suitable way to activate selected portions of the guides.

Such a two-way display can be further designed to have a large-size viewing area with a full aperture, while requiring only one set of column drivers, row drivers and electrodes. No additional absorbers are required and the processing is no more complicated than for a normal foil display. Moreover, apart from the usual light guides used in a conventional foil display, no front lights are needed.

The display may be arranged to display image information independently on each side of the display, or the display may be arranged to display the same information in each direction.

In the first case, the movable element is reflective. Consequently, light from one guide is not scattered into the second guide, and the light guides can be activated alternately and independently of each other. Such a display can be used to reproduce the same or different image content on each side.

In the second case, the movable element is preferably transparent. Consequently, light decoupled from one light guide will pass through the foil and exit on the other side of the display, so that an image will be displayed on both sides of the display. Such a display can be used to display an image (on one or both sides of the display) alternately with different light guides. (Of course, the image will be mirrored on one side.) By arranging the light guides to emit light with different properties, e.g. different polarization, such a display can be used as a 3D display with the help of suitable visual aids (e.g. glasses).

The selection means may comprise row and column electrodes and means for applying voltages to the row and column electrodes. By locally generating a potential difference between the electrodes and the movable element, electrostatic forces are exerted on the movable element, pulling it against one of the light guides.

In a display according to the invention, with two active light guides, only one set of column and row electrodes and drivers, and one movable element, are required to provide one image on each side of the device.

The light guides can be formed by two plates of transparent material, such as glass. The movable element is then sandwiched between these plates to form a compact display with a two-way display capacity.

The display device may comprise light-emitting means for introducing light into the light guides. This light can then be decoupled from the light guides in areas where the movable element is brought into contact with the light guides.

The light-emitting means may be arranged to emit UV light into the light guides, and the display device comprises elements for emitting visible light when excited by UV radiation.

According to a preferred embodiment, the light-emitting means are arranged to alternately introduce light into said first and second light guides. By appropriate control of such light sources, it is possible to prevent undesired interference of images generated on the two sides of the display.

These and other aspects of the invention are apparent from the preferred embodiments which will be more clearly described with reference to the appended drawings.

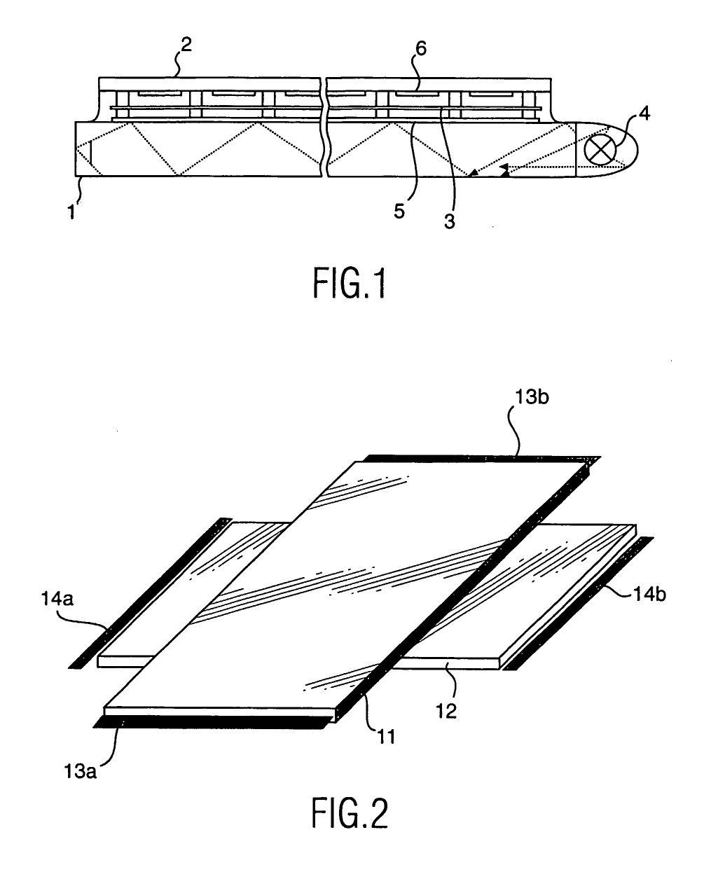

FIG. 1 shows schematically a foil display according to the prior art.

FIG. 2 shows schematically an arrangement with two light guides according to the present invention.

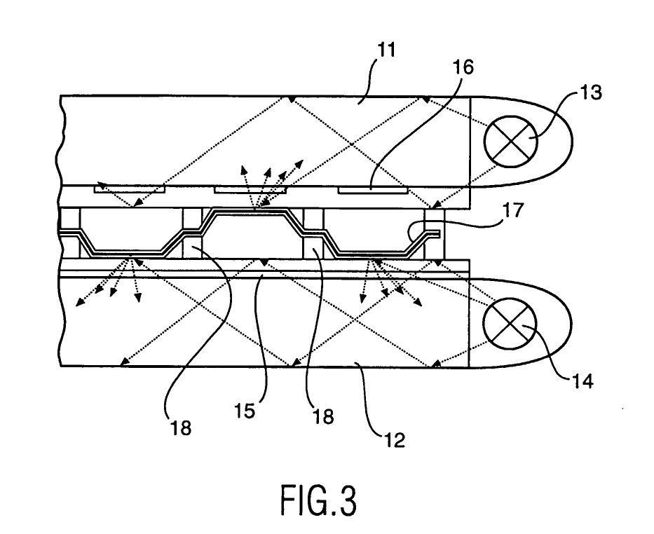

FIG. 3 shows in a cross-section a display according to an embodiment of the invention.

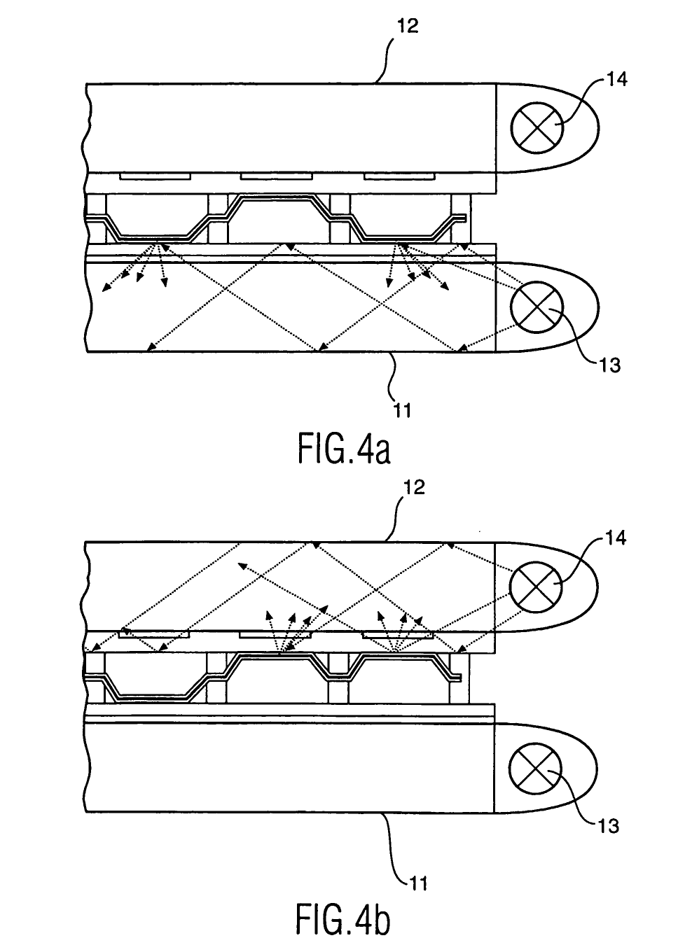

FIGS. 4a and 4b show the display in FIG. 3 used for displaying different images in two directions.

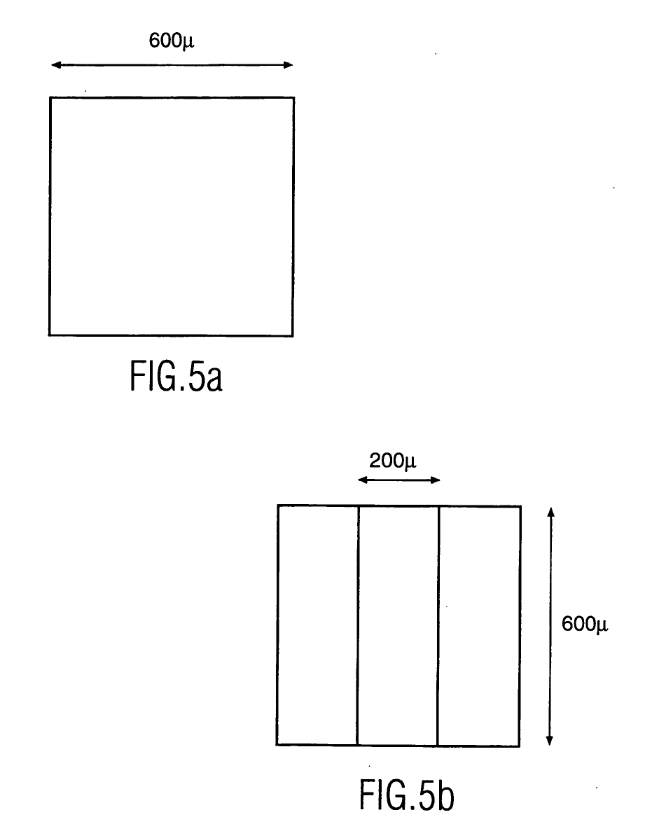

FIG. 5a-b shows three different pixel layouts.

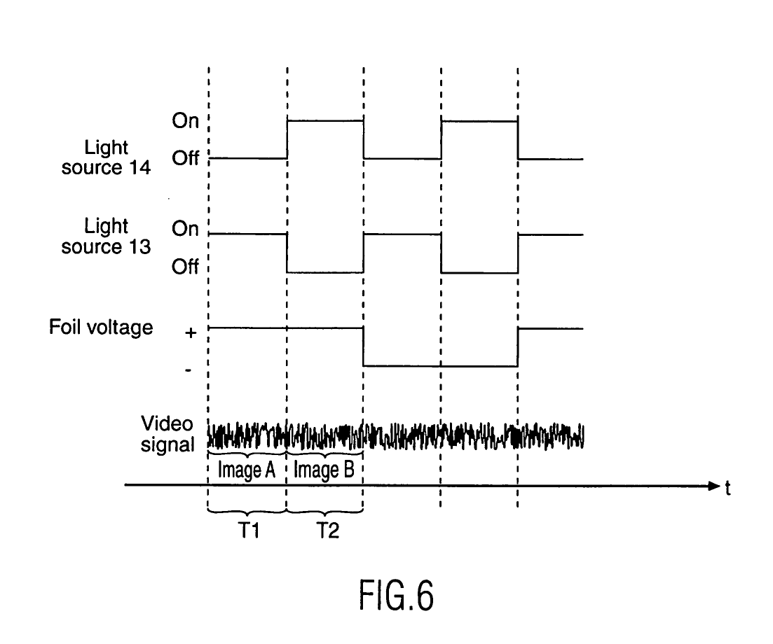

FIG. 6 is a diagram illustrating how two sets of video data are displayed by the display in FIG. 3.

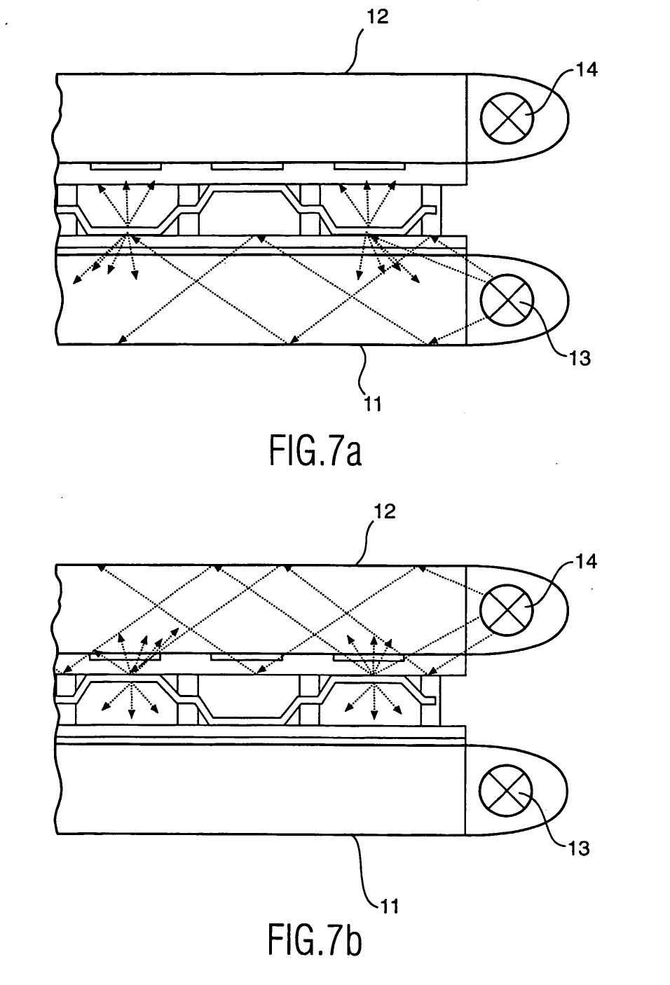

FIG. 7 shows the display in FIG. 3 used for displaying an image with alternating optical properties.

A foil display according to the prior art is illustrated in FIG. 1 and comprises two glass plates 1, 2, and a movable element 3 in the form of a thin foil clamped in between these plates. A light source 4 is arranged in connection to the edge of one of the plates 1 (active plate) while the other plate 2 is passive. The active and the passive plate are provided with sets of parallel (and transparent) electrodes 5, 6 which are arranged perpendicularly with respect to each other. The electrodes are coated with a dielectric layer, such as SiO₂. Appropriate voltage pulses can be applied to two crossing electrodes to generate an electrostatic field which can force the foil 3 (in the area defined by the crossing of the electrodes) into contact with either of the two plates 1, 2. When the foil 3 is brought into contact with the active plate 1, acting as a light guide, light is decoupled from the light guide, thereby causing emission of light from the display and allowing representation of an image. In a variant of such a display (WO 00/50949) the light source emits UV radiation, and the active plate is coated with phosphor particles for emitting visible light when excited by the UV radiation.

An arrangement according to the present invention is shown in FIG. 2, where both glass plates 11, 12 are used as active light guides, with independent light sources 13a, 13b, 14a, 14b arranged in connection to each light guide 11, 12. In FIG. 2, the two pairs of light sources 13a, 13b, 14a, 14b are located at the edges of the two glass plates 11, 12.

A cross-section of a two-light guide foil display according to an embodiment of the invention is shown in FIG. 3. Electrodes 15, 16 are provided on the plates 11, 12 similarly as in the conventional display shown in FIG. 1. A foil 17 is clamped by a symmetric arrangement of spacers 18 between the two glass plates 11, 12. The composition of the foil 17 is also symmetric with respect to the plates 11, 12. The foil 17 may be made of Parylene, and light scattering particles, e.g. TiO₂, may be incorporated in the Parylene.

Light can now be extracted from either glass plate 11, 12 by application of voltages which displace the foil 17 so that it is in contact with the respective light guide 11, 12. In order to create an image consisting of a pattern of on and off-pixels from only one of the light guides 11, it is necessary to turn the light sources on the other light guide 12 off during the creation of that image.

Due to the inherently short switching time of the foil display, it is feasible to exploit the above-described features to form a display alternately emitting light from the two light guides in the following way.

Two pairs of flashing light sources, e.g. LEDs modulated in accordance with a desired scheme, are used to emit light for a period of time (e.g. 8 ms) alternate into one of the two light guides. In this manner, the display can be switched fast between the two states depicted in FIGS. 4a, 4b. The driver electronics are synchronized with the modulated LEDs, and every period (e.g. 8 ms) the video data corresponding to a full screen content is applied to the electrodes of the foil display.

A multiline addressing scheme can advantageously be used to address the electrodes. Different gray scales can be generated by pulse-duration modulation or control of the LED intensities.

A color version of the display according to the present invention can be achieved in a sequential manner by using color LEDs. However, for VGA applications with 8 bit gray scales, this addressing method requires fast switching of the individual pixels, see FIG. 5a.

As an alternative, it is therefore proposed to use the conventional pixel layout (200 um wide×600 um high), and instead define one pixel by three neighboring sub-pixels. It is thus possible to regulate the amount of light emitted from a pixel by controlling three sub-pixels independently, see FIG. 5b. In this way, a spatial modulation of the three sub-pixels can be used to achieve additional gray scaling, relaxing the temporal constraints on the switching of the foil. For example, with three sub-pixels, eight gray levels can be accomplished simply by switching on the correct number of sub-pixels, i.e. no modulation is necessary.

According to a first embodiment of the invention, shown in FIGS. 4a, 4b, the foil 17 according to this embodiment is reflective. This can be accomplished by including a central layer of Al in the Parylene, acting both as a reflector and as an (unstructured) electrode. The TiO₂ particles can be incorporated on both sides of the Al layer.

FIGS. 4a and 4b illustrate how such a display can be used to display different (or identical) images independently on both sides of the display.

When a light source 13, 14 is activated, light is scattered by the foil 17 in areas where it has been brought into contact with the corresponding light guide 11, 12, and due to the reflective layer will only exit the light guide in one direction.

Thus, the reflective properties of the foil 17 prevent the light extracted from one light guide 11 from passing through the second light guide 12 and causing a ghost image in this second viewing direction.

As mentioned above, a full set of video data is provided to the electrodes, and the light guides are alternately switched on and off. With an appropriate choice of video processing, two sets of video data can be sent to the foil display in such a way that two different and independent images are visible on the front and rear sides of the foil display. This is illustrated in FIG. 6.

During the first time interval T1, the video signal fed to the display contains first image information (image A). At the same time, and synchronized with this duration, the first light source 13 is activated (ON), while source 14 is deactivated (OFF). Thus, light guide 11 will display image A. During the second time interval T2, the video signal contains second image information (image B), and the second light source 14 is activated (ON), while source 13 is deactivated (OFF), so that light guide 12 will display image B. This process continues, resulting in one image flashing rapidly on each light guide. If the flashing is fast enough (8 ms was mentioned above), the human eye will perceive the flashing image as one image.

FIG. 6 also shows the foil voltage, which is switched every frame or every two frames. This is a conventional technique in the field of foil displays, in order to avoid build-up of a DC charge in the panel. This means that the column and row addressing voltages resulting from the video signal need to be inverted between positive (+) and negative (−) foil voltages.

Note that, as shown in FIG. 6, the second image information must be processed to result in a correct image on the other side of the display. This is because the foil 17 makes contact with the opposite light guide, and without processing, the conventional image signal would result in a mirrored image. Of course, this processing can be implemented by the display driver itself, or in circuitry preceding the display driver.

There are a number of interesting applications for such a bi-directional foil display. Most notably, the use of two instead of one active plate does not place additional constraints on the scalability of the foil display, and thus additional applications with display sizes ≧30″ are conceivable.

In the work and study environment (offices, libraries, computing centers, internet cafes, etc.) two video outputs can be processed and displayed, using only one display. Thus, two users can work on the same display, saving cost and space.

In information displays at airports, stations and hotel/conference center entrance areas, two identical displays are often used back to back to display identical or different information to two sides, e.g. Schiphol Airport (departure and arrival times of planes). Using the current invention, this could be done at reduced cost with one display having two viewing areas.

A bi-directional display may be used to advantage in a two-player game where the two players are virtually located at different positions or have different information, e.g. Battleship (“Zeeslag”).

Of course, for smaller-size applications, two-way telephone displays can be used at little or no extra cost.

According to a second embodiment, the foil 17 is transparent, and the light guides are arranged to emit light with different optical properties (e.g. polarization, wavelength, etc.).

FIGS. 7a, 7b illustrate how such a device can be operated to display an image alternate with different optical properties. Elements corresponding to the elements in FIGS. 4a, 4b have been given identical reference numerals.

In this case, when a light source 13, 14 is activated, and light is scattered by the foil 17, it will exit the activated light guide on both sides.

Again, a full set of video data is provided to the electrodes, and the light guides are alternately switched on and off. With an appropriate choice of video processing, an image can be reproduced by alternately the first and the second light guides, each emitting light with different properties. The result is a displayed image having alternating optical properties. It should be noted that, as shown in FIGS. 7a, 7b, this image is displayed on both sides of the display. Of course, one side of the display can be covered if a one-sided display is desired.

With reference to the diagram in FIG. 6, the process for operating the display in FIGS. 7a, 7b is similar to the process described above. However, the display signal does not include two interleaved image signals (A and B), but only one image signal (image A), which is alternately inverted in order to bring the foil in contact with alternating light guides. Such an inversion can be implemented in the driver electronics. If the display is used in e.g. a 3D application, the image signal may in fact comprise two slightly different images, A and A′, in order to generate the 3D effect.

The advantages regarding display size are the same as in the bi-directional display described above.

1. A display device comprising a first light guide, a movable element and selection means for locally bringing the movable element into contact with said light guide, characterized in that the display device comprises a second light guide, wherein said movable element is arranged in between said light guides, and wherein said selection means are arranged to locally bring the movable element into contact with a selected one of said light guides.

2. A display device as claimed in claim 1, wherein said movable element is reflective.

3. A display device as claimed in claim 1, wherein said movable element is transparent.

4. A display device as claimed in claim 1, wherein said selection means comprise row and column electrodes and means for applying voltages to the row and column electrodes.

5. A display device as claimed in claim 1, further comprising light-emitting means for introducing light into said light guides.

6. A display device as claimed in claim 5, wherein said light-emitting means are arranged to emit UV light into the light guides, and wherein the display device comprises elements for emitting visible light when excited by UV radiation.

7. A display device as claimed in claim 5, wherein said light-emitting means are arranged to alternately introduce light into said first and second light guides.

8. A display device as claimed in claim 1, wherein said light guides are formed by plates of a transparent material, sandwiching the movable element between them.
